(19) United States
(12) Patent Application Publication
(10) Pub. No.: US 2025/0246021 A1
(43) Pub. Date: Jul. 31, 2025

(54) FACIAL EXPRESSION RECOGNITION METHOD AND SYSTEM BASED ON MULTI-CUE ASSOCIATIVE LEARNING

(71) Applicant: CENTRAL CHINA NORMAL UNIVERSITY, Hubei (CN)

(72) Inventors: Jingying Chen, Hubei (CN); Ruyi XU, Hubei (CN); Zongkai YANG, Hubei (CN); Zhaoyang MA, Hubei (CN)

(73) Assignee: CENTRAL CHINA NORMAL UNIVERSITY, Hubei (CN)

(21) Appl. No.: 19/078,179

(22) Filed: Mar. 12, 2025

Related U.S. Application Data
(63) Continuation of application No. PCT/CN2023/091198, filed on Apr. 27, 2023.

(30) Foreign Application Priority Data
Mar. 22, 2023 (CN) 202310288548.X

(51) Int. Cl. G06V 40/16; G06V 10/80; G06V 10/82

(52) U.S. Cl. CPC G06V 40/174; G06V 10/806; G06V 10/82; G06V 40/168

(57) ABSTRACT

The present invention provides a facial expression recognition method and system based on multi-cue associative learning, belonging to the technical field of computer vision. The recognition method comprises: inputting a pre-recognized facial image into a student model and/or a teacher model for facial expression recognition. A training method comprises: cropping a global facial sample image to obtain an upper half facial sample image and a lower half facial sample image; extracting cue features; acquiring adjacency matrices corresponding to the upper half facial sample image, the lower half facial sample image and the global facial sample image; fusing associated semantics by using a feature-level attention mechanism, so as to acquire the teacher model; supervising training of the teacher model by using a cross-entropy loss; and supervising training of the student model by using label distillation, KL divergence and a cross-entropy loss.

### CROSS-REFERENCE TO RELATED APPLICATION

This application is a continuation of international application of PCT application serial no. PCT/CN2023/091198 filed on Apr. 27, 2023, which claims the priority benefit of China application no. 202310288548.X filed on Mar. 22, 2023. The entirety of each of the above-mentioned patent applications is hereby incorporated by reference herein and made a part of this specification.

### BACKGROUND

### Technical Field

The present invention belongs to the technical field of computer vision, more specifically, relates to a facial expression recognition method and system based on multi-cue associative learning.

### Description of Related Art

Automatic facial expression recognition, which aims to infer the underlying emotional state from facial images based on facial muscle movements, is a challenging task for computer vision task. Psychologists have pointed out that the associated semantic information of facial expressions is scattered around various facial organs, with the upper and lower halves of the face carrying different amounts of semantic information. Different combinations of semantic information represent entirely different emotional meanings. More importantly, this semantic information is sensitive and fragile and is easily affected by changes in lighting, partial occlusion, head posture, and even identity or makeup features. Therefore, a favorable facial expression recognition model is urgently needed to be designed to comprehensively address all of the above problems.

A graph convolutional network is a type of neural network that performs convolution operations on a graph data structure. It originates from the convolutional neural networks in deep learning, but it may be used in non-Euclidean domains where convolutional neural networks are not proficient. The graph convolutional network inherits most of the advantages of deep learning and exhibits strong manifold representation abilities for nodes, edges, or subgraphs of graphs.

Associative learning is a feasible and promising solution. Associative learning originates from psychologists' observations of the learning processes in animals and humans. The famous Pavlov experiment demonstrates that animals have the ability to associate different stimulus signals during the learning process. Associationism holds that human learning ability comes from the establishment of various connections. In a pattern recognition task, humans possess the ability to associate cues with labels, as well as the ability to associate individuals with similar cues. When humans purposefully tap into their potential for associative learning, they often achieve better learning effects. Inspired by associative learning, some existing facial expression recognition works establish associative relationships among different training samples through specified cues by means of graph convolutional networks, so that a model is enabled to learn potential semantic features that conform to these associative rules, and the representational ability of the model is thereby enhanced.

Existing works neglect some key characteristics of human associative learning, including: 1. human associative learning is often multi-cue based and does not rely on one single cue to establish associative rules; 2. human associative learning has a specific attention mechanism, and the knowledge of the semantics learned by different associative rules with the attention mechanism is integrated based on learning experience. These issues lead to limitations in the application of existing methods, resulting in low recognition accuracy. Leveraging the advantages of associative learning and graph social networks may help solve the above problems, but there are no publicly available methods on how to further optimize associative learning and graph convolutional networks for multi-cue facial expression recognition in the related art.

### SUMMARY

In view of the defects of the related art, the present invention aims to provide a facial expression recognition method and system based on multi-cue associative learning and aims to solve the problem of limitations in facial expression recognition methods and their relatively low recognition accuracy in the related art.

To achieve the foregoing purpose, in one aspect, the present invention provides a facial expression recognition method based on multi-cue associative learning, and the following steps are included:
inputting a pre-recognized facial image into a student model and/or a teacher model for facial expression recognition,
wherein a training method of the student model and the teacher model comprises following steps:
D1: cropping a global facial sample image to obtain an upper half facial sample image and a lower half facial sample image in a horizontal direction;
D2: extracting cue features from the global facial sample image, the upper half facial sample image, and the lower half facial sample image;
D3: calculating an association relationship among the cue features corresponding to the upper half facial sample image, the lower half facial sample image, and the global facial sample image, and acquiring corresponding adjacency matrices;
D4: with the cue features and the adjacency matrices as input, outputting associated semantics by using three graph convolutional networks and fusing the associated semantics by using a feature-level attention mechanism, so as to acquire the teacher model; and
D5: inputting the fused associated semantics in the teacher model into a classification layer, supervising training of the teacher model by using a cross-entropy loss, and supervising training of the student model by using label distillation, Kullback-Leibler (KL) divergence, and a cross-entropy loss together, wherein the student model is constructed by a fully-connected layer input after the cue features pass through a bottleneck layer.

Further preferably, the teacher model is constructed in one of two approaches:
wherein the first approach is:
outputting global associated semantics by treating the cue features of the global facial sample image as a first input for the three graph convolutional networks, and treating the adjacency matrices corresponding to the global facial sample image, the upper half facial sample image, and the lower half facial sample image as a second input for a first, second, and third graph convolutional networks respectively; and fusing the global associated semantics by using the feature-level attention mechanism, so as to acquire the teacher model;
the second approach is:
outputting the global associated semantics, upper half facial sample associated semantics, and lower half facial sample associated semantics respectively by treating the cue features corresponding to the global facial sample image, the upper half facial sample image, and the lower half facial sample image as the first input for the first, second, and third graph convolutional networks respectively, and treating the adjacency matrices corresponding to the global facial sample image, the upper half facial sample image, and the lower half facial sample image as a second input for the first, second, and third graph convolutional networks respectively; and fusing the global associated semantics, the upper half facial sample associated semantics, and the lower half facial sample associated semantics by using the feature-level attention mechanism, so as to acquire the teacher model.

Further preferably, the method for extracting the cue features includes: performing feature extraction by using a local binary pattern (LBP) operator; or directly extracting deep features by using a public and trained face model; or fine-tuning a pre-trained face model by using labeled samples to acquire a deep model and then extracting deep embedding features by using the deep model.

Further preferably, a cross-entropy loss function of the teacher model is:

$${ℒ}_{c l s}^{t} = - {\sum }_{i = 1}^{n} {y}_{i} log {\hat{y}}_{i}^{t} ,$$

where ŷᵢ^{t} represents a sample label distribution predicted by the fully-connected layer of the fused associated semantics F(xᵢ) in the teacher model, and yᵢ represents a true distribution of the sample.

Further preferably, a total loss function of the student model includes a distillation loss function and a cross-entropy loss function of the student model, specifically is:

$$\begin{matrix}{ℒ}_{s} = {ℒ}_{cls}^{s} + {ℒ}_{KL} , \\ {ℒ}_{cls}^{s} = - {\sum }_{i = 1}^{n} {y}_{i} log {\hat{y}}_{i}^{s} , {ℒ}_{KL} = - {\sum }_{i = 1}^{n} f ( {\hat{y}}_{i}^{s} / T ) log \frac{f ( {\hat{y}}_{i}^{t} / T )}{f ( {\hat{y}}_{i}^{s} / T )} ,\end{matrix}$$

where [symbol] _{cls}^{s} represents the cross-entropy loss of the student model, ŷᵢ^{s} represents a probability distribution predicted by the student model, [symbol] _{KL} is a distillation loss, f(.) represents a softmax activation function, T represents a distillation temperature, and ŷᵢ^{t} represents a sample label distribution predicted by the fully-connected layer of the fused associated semantics F(xᵢ) in the teacher model.

In another aspect, the present invention provides a facial expression recognition system based on multi-cue associative learning, including:
a student model expression recognition module, configured to input a pre-recognized facial image into a storage module of a student model to perform facial expression recognition;
a teacher model expression recognition module, configured to input the pre-recognized facial image into a storage module of a teacher model to perform facial expression recognition;
a global facial sample image preprocessing module, configured to crop a collected global facial sample image to obtain an upper half facial sample image and a lower half facial sample image in a horizontal direction;
a feature extraction module, configured to extract cue features from the global facial sample image, the upper half facial sample image, and the lower half facial sample image;
an adjacency matrix acquisition module, configured to calculate an association relationship among the cue features corresponding to the upper half facial sample image, the lower half facial sample image, and the global facial sample image, and acquire adjacency matrices corresponding to the upper half facial sample image, the lower half facial sample image, and the global facial sample image;
a teacher model construction module, configured to, with the cue features and the adjacency matrices as input, output associated semantics by using three graph convolutional networks and fuse the associated semantics by using a feature-level attention mechanism, so as to acquire the teacher model; and
a model training module, configured to input the fused semantics association in the teacher model into a classification layer, supervise training of the teacher model by using a cross-entropy loss function of the teacher model, and supervise training of the student model by using label distillation, Kullback-Leibler (KL) divergence, and a cross-entropy loss of the student model together.

Herein, the student model is constructed by a fully-connected layer input after the cue features pass through a bottleneck layer.

Further preferably, the teacher model is constructed in one of two approaches:
the first approach is:
outputting global associated semantics by treating the cue features of the global facial sample image as a first input for the three graph convolutional networks, and treating the adjacency matrices corresponding to the global facial sample image, the upper half facial sample image, and the lower half facial sample image as a second input for a first, second, and third graph convolutional networks respectively; and fusing the global associated semantics by using the feature-level attention mechanism, so as to acquire the teacher model;
the second approach is:
outputting the global associated semantics, upper half facial sample associated semantics, and lower half facial sample associated semantics respectively by treating the cue features corresponding to the global facial sample image, the upper half facial sample image, and the lower half facial sample image as the first input for the first, second, and third graph convolutional networks respectively, and treating the adjacency matrices corresponding to the global facial sample image, the upper half facial sample image, and the lower half facial sample image as a second input for the first, second, and third graph convolutional networks respectively; and fusing the global associated semantics, the upper half facial sample associated semantics, and the lower half facial sample associated semantics by using the feature-level attention mechanism, so as to acquire the teacher model.

Further preferably, a cross-entropy loss function of the teacher model is:

$${ℒ}_{cls}^{t} = - {\sum }_{i = 1}^{n} {y}_{i} log {\hat{y}}_{i}^{t} ,$$

where ŷᵢ^{t} represents a sample label distribution predicted by the fully-connected layer of the fused associated semantics F(xᵢ) in the teacher model, and y; represents a true distribution of the sample.

Further preferably, a total loss function of the student model includes a distillation loss function and a cross-entropy loss function of the student model, specifically:

$${ℒ}_{s} = {ℒ}_{cls}^{s} + {ℒ}_{KL} , \\ {ℒ}_{cls}^{s} = - {\sum }_{i = 1}^{n} {y}_{i} log {\hat{y}}_{i}^{s} , and \\ {ℒ}_{KL} = - {\sum }_{i = 1}^{n} f ( {\hat{y}}_{i}^{s} / T ) log \frac{f ( {\hat{y}}_{i}^{t} / T )}{f ( {\hat{y}}_{i}^{s} / T )} ,$$

where [symbol] _{cls}^{s} represents the cross-entropy loss of the student model, ŷᵢ^{s} represents a probability distribution predicted by the student model, [symbol] _{KL} is a distillation loss, f(.) represents a softmax activation function, T represents a distillation temperature, and ŷᵢ^{t} represents a sample label distribution predicted by the fully-connected layer of the fused associated semantics F(xᵢ) in the teacher model.

To sum up, the above technical solutions provided by the present invention have the following beneficial effects compared with the related art.

The present invention provides a facial expression recognition method and system based on multi-cue associative learning, in which facial expression is divided into upper and lower half faces to guide associative learning based on local cues. While effectively addressing the problem of local occlusion, different associative cues are better utilized to enhance the model's learning ability. A multi-cue associative learning method based on graph convolutional networks is provided to solve the problem of expression recognition in natural scenarios.

The present invention provides a facial expression recognition method and system based on multi-cue associative learning, where a feature-level attention mechanism effectively integrates the knowledge of multi-cue associative learning, making the model more consistent with human associative learning mechanisms, so the complex and varied challenges in natural scenarios are better addressed.

The present invention provides a facial expression recognition method and system based on multi-cue associative learning, where the student model and the teacher model are further optimized by using knowledge distillation. On one hand, knowledge distillation may regard associative learning as a regularization peak of a conventional convolutional network, so the computational resources required by the model during the testing phase are reduced. On the other hand, the collaborative training of the teacher model and the student model can further optimize the backbone network of the model, so the performance of the teacher model is further improved.

### BRIEF DESCRIPTION OF THE DRAWINGS

FIG. 1 is a flow chart of a facial expression recognition method based on multi-cue associative learning provided by an embodiment of the present invention.

FIG. 2 is a schematic image of facial expression data after preprocessing provided by an embodiment of the present invention.

FIG. 3 is a structural schematic view of a teacher model and a student model provided by an embodiment of the present invention.

### DESCRIPTION OF THE EMBODIMENTS

In order to make the objectives, technical solutions, and advantages of the present invention clearer and more comprehensible, the present invention is further described in detail with reference to the drawings and embodiments. It should be understood that the specific embodiments described herein serve to explain the present invention merely and are not used to limit the present invention.

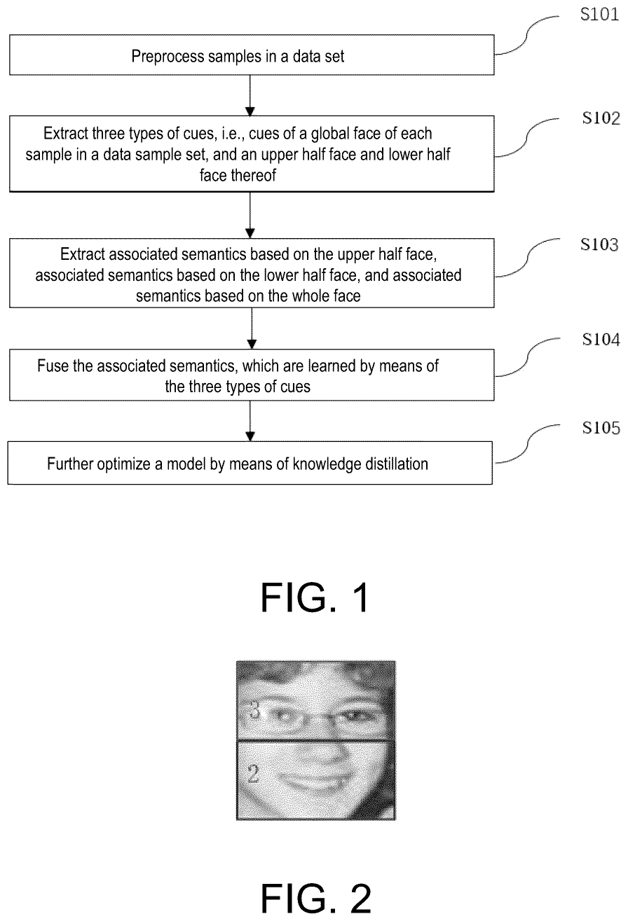

As shown in FIG. 1, in one aspect, the present invention provides a facial expression recognition method based on multi-cue association, including the following steps.

S101: Preprocessing is performed on a global facial sample image.

Since the semantic information carried by the upper and lower halves of a person's face has its own associative characteristics (different expressions have overlapping AUs (Action units) on the upper half of the face, especially AU1, AU4, and AU5, while they are mostly mutually exclusive on the lower half of the face), and the upper and lower halves of the face occlusion have different application scenarios (for example, upper face occlusion may be used for emotion recognition when wearing VR glasses, and lower half face occlusion may be used for emotion recognition when wearing masks), the upper face half, the lower face half, and the global face are treated as associative cues in the present invention, so as to guide multi-cue associative learning.

Further, before a global facial sample image is input in the next step for feature extraction, a sample is first preprocessed. That is, as shown in FIG. 2, the global facial sample image is evenly cropped in a horizontal direction into upper and lower two parts, the upper part being an upper half face, the lower part being a lower half face, and the original image being a global face.

S102: Feature extraction is perform, that is, the global face of each sample in a global facial sample image set and three clues of the upper and lower half faces are extracted.

Further, the feature extraction of samples may preferably adopt one of the following three approaches:

Approach a, feature extraction is performed by using a local binary pattern (LBP) operator.

LBP is an operator used to describe local texture features of images, with notable advantages such as rotation invariance and grayscale invariance. The specific calculation of the LBP operator is as follows: In a 3×3 window, a grayscale value of a center pixel in the window is treated as a threshold and is compared with the grayscale values of the surrounding eight pixels. If the surrounding pixel's value is greater than that of the center pixel, it is marked as 1; otherwise, it is 0. In this way, after comparing the 8 pixels in the 3×3 neighborhood, an 8-bit binary number may be produced. This is usually converted to a decimal number, i.e., the LBP code, with 256 possible values. The final result is the LBP value of the center pixel in this window, and this value is used to reflect the texture information of this region. Expressed as an equation, it is:

$$LBP ( {x}_{c} , {y}_{c} ) = {\sum }_{p = 1}^{s} s ( I ( p ) - I ( c ) ) \times {2}^{P} ,$$

where, l(p) represents the grayscale value of the p^{th} pixel in the window except for the center pixel, l(c) represents the grayscale value of the central pixel, s(.) is a threshold function, and the formula is expressed as follows:

$$s ( x ) \{ \begin{matrix}1 , & x \geq 0 \\ 0 , & x < 0\end{matrix} .$$

Since LBP records a difference value between neighboring pixel points and a center pixel point, when changes in illumination cause the grayscale values of pixel points within the window to synchronously increase or decrease, the LBP value does not change significantly. Therefore, LBP may not be sensitive to illumination changes.

Approach b, a deep feature extraction is performed, which uses a public and trained face model to directly extract features of the global facial sample image.

In this feature extraction method of this embodiment, a ResNet18 network model is used to read network parameters from a pre-trained face model Ms-Celeb-1M. All global facial sample images are directly input into the ResNet18 network, and the 512-dimensional vector before the last fully-connected layer in the ResNet18 network is output as the depth feature of the data sample in this embodiment.

Approach c, the pre-trained face model Ms-Celeb-1M is fine-tuned by means of labeled samples to acquire a deep model and the acquired deep model is used to extract deep embedding features of all global facial sample images finally.

In this feature extraction method of this embodiment, the ResNet18 network model is used as well to read the network parameters from the pre-trained face model Ms-Celeb-1M. All labeled samples are treated as training set data for the ResNet18 model to fine-tune the parameters of the network in the face model, and a fine-tuned depth model used for the data samples in this embodiment is thus obtained. All data samples are then directly input into the fine-tuned depth model of this feature extraction method, and a 512-dimensional vector is output from the layer before the last fully-connected layer of the entire network, which acts as the depth embedding feature of the current data sample.

The features obtained from the above three approaches for feature extraction may all act as the feature vectors of the samples in this embodiment.

S103: Associative learning is performed, which is used to extract associated semantics based on the upper half face, associated semantics based on the lower half face, and associated semantics based on the global face.

In the associative learning, association between samples may be represented by a graph model [symbol] =(V, E). Each sample xᵢϵV is treated as one node on the graph, and an edge aᵢⱼ∈E between any two samples represents the association between the samples. An increase in a weight of aᵢⱼ indicates that the association between the samples is greater. If the weight of aᵢⱼ is 0, it is considered that there is no association between the two samples.

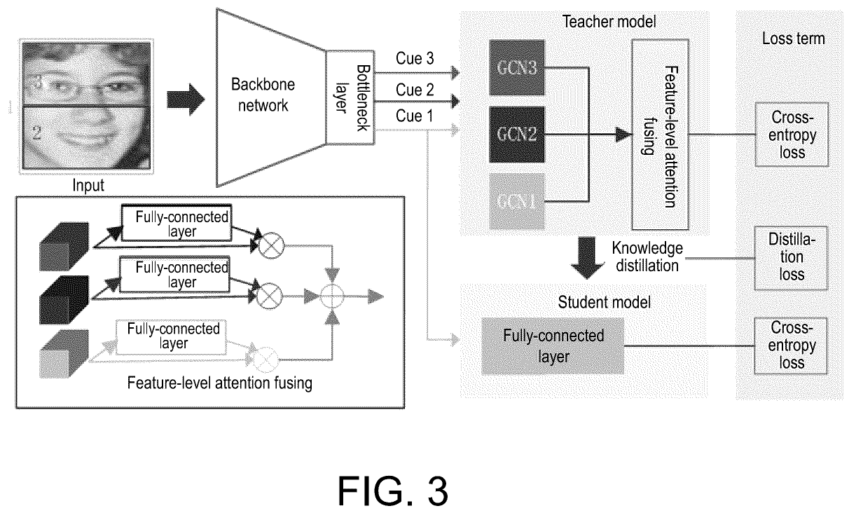

As shown in FIG. 3, in a graph convolutional network, the teacher model trains a network parameter W based on semantic features provided by the nodes and an adjacency matrix A∈R^{n×n} representing an associative relationship between the nodes. When the graph convolutional network is trained in batches, n represents a size of the mini-batch. Each element in the adjacency matrix may be represented by aᵢⱼ. Given a clue c, feature representation corresponding to the i^{th} sample is xᵢ^{c}, and the equation for calculating the adjacency matrix is expressed as follows:

$${A}^{c} = {( {a}_{ij} )}_{n \times n} = \{ \begin{matrix}d ( {x}_{i}^{c} , {x}_{j}^{c} ) & d ( {x}_{i}^{c} , {x}_{j}^{c} ) \geq κ \\ 0 & d ( {x}_{i}^{c} , {x}_{j}^{c} ) < κ\end{matrix} ,$$

where κ is an empirical parameter used to control the number of sample pairs with associative relationships, when different associative clues exist, multiple adjacency matrices may be obtained, the adjacency matrices are constructed by using three cues of the upper half face, the lower half face, and the global face in the present invention, xᵢ and xⱼ represent any two samples in one training batch, xᵢ¹ represents the clue feature extracted from the global face through a backbone network, and xᵢ² and xᵢ³ represent the clue features extracted from the upper half face and lower half face through the backbone network, respectively.

According to the adjacency matrices constructed based on different cues, independent graph convolutional networks may be adopted to learn the guided associative knowledge. Therefore, three GCNs (graph convolutional networks) are arranged in the present invention. Herein, in each graph convolutional network, there are two inputs, and each network contains two graph convolutional layers. One input is the cue feature, and the other input is the adjacency matrix. Herein, the equation for calculating the adjacency matrix is expressed as follows:

$${H}^{( h + 1 )} = σ ( {\hat{A}}^{c} {H}^{( h )} W ) ,$$

where Â^{c} represents the normalized adjacency matrix, which is calculated as Â^{c}=\tilde{D}^{-1/2}Ã^{c}\tilde{D}^{-1/2} and Ã^{c}=A^{c}+Iₙ, Iₙ∈ [symbol] ^{n×n} represents an identity matrix, W is the trainable parameter of the graph convolutional network, σ((x)=Relu(x)=max(0, x), H^{(h)} represents the input of the h^{th} layer of the graph convolutional network, and H⁽¹⁾ is a sample clue feature provided by the bottleneck layer of the convolutional neural network backbone.

Further, a distance between a sample and another sample is preferably calculated using Euclidean distance; however, other equations representing differences may also be adopted for distance calculation.

There are two approaches to construct H^{(h)}, specifically as follows.

In one embodiment, the cue features corresponding to the global facial sample image are input into all three graph convolutional networks, that is

H₁⁽¹⁾H₂⁽¹⁾=H₃⁽¹⁾=xᵢ¹,

where xᵢ¹ represents the feature extracted from the global face through the backbone network, and based on this approach, the outputs of the three graph convolutional networks are also global associated semantics.

In another embodiment, the cue features corresponding to the construction of the adjacency matrices are input to the three graph convolutional networks, that is

H₁⁽¹⁾={xᵢ¹};H₂⁽¹⁾={xᵢ²};H₃⁽¹⁾={xᵢ³}.

xᵢ² and xᵢ³ represent the clue features extracted from the upper half face and lower half face respectively. In this approach, the three graph convolutional networks output one global associated semantics and the upper and lower half facial sample associated semantics.

In the above two embodiments, the adjacency matrices used for the corresponding GCN are the same, that is, for the c^{th} GCN, regardless of the approach that H(h) is generated, its adjacency matrix is always Ac.

Regardless of which embodiment above is adopted, the next step introduces an attention mechanism for feature fusion, which is used to integrate the associated knowledge guided by different cues.

S104: Associated semantics fusion is performed, which is used to fuse the associated semantics learned from the three cues, so as to complete the construction of the teacher model.

In the present invention, the features HC-output by different graph convolutional networks are adaptively fused by means of a feature-level attention mechanism, so as to simulate the human attention learning mechanism.

Specifically, the attention mechanism may be represented by one trainable fully-connected layer, and the fully-connected layer maps H_{c}⁽²⁾ to one attention weight α_{c}. All features are aggregated according to the attention weight to obtain the final sample feature:

$$F ( {x}_{i} ) = {\sum }_{c} {α}_{c} {H}_{c}^{( 2 )} ( {x}_{i} ) / {\sum }_{c} {α}_{c} ,$$

where α_{c}=G(F(xᵢ)T_{q}), G(.) is a sigmoid function, q is a trainable network parameter of the fully-connected layer, the fused associated semantics may be input into a classification layer, and training is supervised by using a cross-entropy loss:

$${ℒ}_{cls}^{t} = - {\sum }_{i = 1}^{n} {y}_{i} log {\hat{y}}_{i}^{t} ,$$

where ŷᵢ^{t} represents a sample label distribution predicted by the fully-connected layer for feature F(xᵢ), and yᵢ represents a true distribution of the sample. Through the attention mechanism, the knowledge obtained from different associated clues is organically integrated, so the model is enabled to better cope with various challenges. For instance, when the upper half face is occluded or is significantly confused, the clue based on the lower half face obtains a greater fusion weight through the attention mechanism and thus plays a major role in the recognition process, and vice versa.

S105: Further, the model is optimized using knowledge distillation.

In the framework proposed by the present invention, as shown in FIG. 3, the two branches derived from the backbone network correspond to the teacher model and the student model. The teacher model is multi-cue guided associative learning, while the student model is conventional non-associative learning. Knowledge distillation aims to transfer knowledge from the teacher model to the student model, where the student model is the fully-connected layer connected after the bottleneck layer of the convolutional neural network used by the backbone network.

Specifically, the training of the student model is supervised in the present invention by means of label distillation, KL divergence, and a cross-entropy loss:

$${ℒ}_{s} = {ℒ}_{cls}^{s} + {ℒ}_{KL} , \\ {ℒ}_{cls}^{s} = - {\sum }_{i = 1}^{n} {y}_{i} log {\hat{y}}_{i}^{s} , and \\ {ℒ}_{KL} = - {\sum }_{i = 1}^{n} f ( {\hat{y}}_{i}^{s} / T ) log \frac{f ( {\hat{y}}_{i}^{t} / T )}{f ( {\hat{y}}_{i}^{s} / T )} ,$$

where [symbol] _{cls}^{s} represents the cross-entropy loss of the student model, ŷᵢ^{s} represents a probability distribution predicted by the student model, [symbol] _{KL} is a distillation loss, f(.) represents a softmax activation function, and T represents a distillation temperature.

It needs to be emphasized that the student model only uses global features as one cue and does not perform associative learning, and its performance is inferior to the teacher model. However, as two branches of the backbone network, even without the addition of the distillation loss, both have a synergistic effect on optimizing the backbone network. Therefore, the introduction of the student model may serve to optimize the backbone network, and the performance of the teacher model is thereby enhanced. With the addition of the distillation loss, the teacher model may further promote the performance improvement of the student model, so a mutual promotion effect is achieved.

In summary, both the teacher model and the student model are required to be optimized during the training process in the present invention. Therefore, the total loss Ltotal of the model may be specifically represented as:

$${ℒ}_{total} = {ℒ}_{cls}^{t} + {ℒ}_{cls}^{s} + {ℒ}_{KL} .$$

In a testing phase, different branches may be selected for result prediction according to actual situations. For environments with limited computational resources, the teacher model may be removed, and the student model may be used solely to predict the results. For applications pursuing ultimate performance, the prediction results of the teacher model may be selected for expression classification decision. The performance differences between the two branches are compared in detail in the experimental section.

In an embodiment, the RAF-DB (Real-world Affective Faces Database) expression database is adopted. This expression database contains 29,672 facial images collected from the Internet, and the expressions are labeled by 315 staff members (university students and faculty). A total of 7 expressions, namely: anger, disgust, fear, happiness, sadness, surprise, and neutral, are included.

All facial expression images are selected in the present invention, and experiments are conducted according to the training set and the testing set divided by the expression database. In the approach of inputting the global feature into the three graph convolutional networks, the obtained expression recognition accuracy is 88.43%. In the approach of inputting the global feature and features of the upper and lower half faces separately into the three graph convolutional networks, the obtained expression recognition accuracy is 89.62%. After further optimizing the model using the knowledge distillation approach, the optimal expression recognition accuracy obtained is 90.66%.

In another embodiment, the FER+ (Hard-Label) expression database is adopted. This expression database is an extension of the original FER data set, in which facial expression images are relabeled as one of 8 emotion types: neutral, happy, surprised, sad, angry, disgusted, fearful, and contemptuous.

All facial expression images in the data set are selected for training in the present invention. In the approach of inputting the global feature into the three graph convolutional networks, the obtained expression recognition accuracy is 87.68%. In the approach of inputting the global feature and features of the upper and lower half faces separately into the three graph convolutional networks, the obtained expression recognition accuracy is 88.48%. After further optimizing the model using the knowledge distillation approach, the optimal expression recognition accuracy obtained is 89.48%.

In another aspect, the present invention provides a facial expression recognition system based on multi-cue associative learning, including:
a student model expression recognition module, configured to input a pre-recognized facial image into a storage module of a student model to perform facial expression recognition;
a teacher model expression recognition module, configured to input the pre-recognized facial image into a storage module of a teacher model to perform facial expression recognition;
a global facial sample image preprocessing module, configured to crop a collected global facial sample image to obtain an upper half facial sample image and a lower half facial sample image in a horizontal direction;
a feature extraction module, configured to extract cue features from the global facial sample image, the upper half facial sample image, and the lower half facial sample image;
an adjacency matrix acquisition module, configured to calculate an association relationship among the cue features corresponding to the upper half facial sample image, the lower half facial sample image, and the global facial sample image, and acquire adjacency matrices corresponding to the upper half facial sample image, the lower half facial sample image, and the global facial sample image;
a teacher model construction module, configured to, with the cue features and the adjacency matrices as input, output associated semantics by using three graph convolutional networks and fuse the associated semantics by using a feature-level attention mechanism, so as to acquire the teacher model; and
a model training module, configured to input the fused semantics association in the teacher model into a classification layer, supervise training of the teacher model by using a cross-entropy loss function of the teacher model, and supervise training of the student model by using label distillation, KL divergence, and a cross-entropy loss of the student model together.

Further preferably, the method for constructing the teacher model includes two approaches.

Herein, the first approach is as follows.

The cue feature of the global facial sample image is treated as a first input for the three graph convolutional networks. The adjacency matrices corresponding to the global facial sample image, the upper half facial sample image, and the lower half facial sample image are treated as a second input for the first, second, and third graph convolutional networks respectively. Global associated semantics is output, and the global associated semantics is fused by using the feature-level attention mechanism, so as to acquire the teacher model.

The second approach is as follows. The cue features corresponding to the global facial sample image, the upper half facial sample image, and the lower half facial sample image are treated as the first input for the first, second, and third graph convolutional networks respectively. The adjacency matrices corresponding to the global facial sample image, the upper half facial sample image, and the lower half facial sample image are treated as the second input for the first, second, and third graph convolutional networks respectively. The global associated semantics, upper half facial sample associated semantics, and lower half facial sample associated semantics are output respectively. The global associated semantics, the upper half facial sample associated semantics, and the lower half facial sample associated semantics are fused by using the feature-level attention mechanism, so as to acquire the teacher model.

Further preferably, the cross-entropy loss function of the teacher model is:

$${ℒ}_{cls}^{t} = - {\sum }_{i = 1}^{n} {y}_{i} log {\hat{y}}_{i}^{t} ,$$

where ŷᵢ^{t} represents a sample label distribution predicted by the fully-connected layer of the fused associated semantics F(xᵢ) in the teacher model, and yᵢ represents a true distribution of the sample.

Further preferably, a total loss function of the student model includes a distillation loss function and a cross-entropy loss function of the student model, specifically:

$${ℒ}_{s} = {ℒ}_{cls}^{s} + {ℒ}_{KL} , \\ {ℒ}_{cls}^{s} = - {\sum }_{i = 1}^{n} {y}_{i} log {\hat{y}}_{i}^{s} , and \\ {ℒ}_{KL} = - {\sum }_{i = 1}^{n} f ( {\hat{y}}_{i}^{s} / T ) log \frac{f ( {\hat{y}}_{i}^{t} / T )}{f ( {\hat{y}}_{i}^{s} / T )} ,$$

where [symbol] _{cls}^{s} represents the cross-entropy loss of the student model, ŷᵢ^{s} represents a probability distribution predicted by the student model, [symbol] _{KL} is a distillation loss, f(.) represents a softmax activation function, T represents a distillation temperature, and ŷᵢ^{t} represents a sample label distribution predicted by the fully-connected layer of the fused associated semantics F(xᵢ) in the teacher model.

More specifically, knowledge distillation includes:
the two branches derived from the backbone network correspond to the teacher model and the student model. The teacher model is multi-cue guided associative learning, while the student model is conventional non-associative learning. Knowledge distillation aims to transfer knowledge from the teacher model to the student model.

Further preferably, both the teacher model and the student model are required to be optimized during the training process. While in the testing phase, different branches may be selected for result prediction according to actual situations. For environments with limited computational resources, the teacher model may be removed, and the student model may be used solely to predict the results. For applications pursuing ultimate performance, the prediction results of the teacher model may be selected for expression classification decision.

The implementation principle and technical effects of the system are similar to those of the aforementioned method, so description thereof is not repeated herein.

The embodiments of the present invention further provide a storage medium, which stores a computer program. The computer program is executed by a processor to implement the technical solution of the facial expression recognition method based on multi-cue associative learning in any of the above embodiments. The implementation principle and technical effects thereof are similar to those of the aforementioned method, so description thereof is not repeated herein.

It must be noted that in any of the above embodiments, the method may not necessarily be executed sequentially according to the step numbers. As long as it cannot be inferred from the execution logic that the steps must be executed in a specific order, it means that they may be executed in any other possible order.

In view of the foregoing, compared to the related art, advantages of the present invention include the following.

The present invention provides a facial expression recognition method and system based on multi-cue associative learning, in which facial expression is divided into upper and lower half faces to guide associative learning based on local cues. While effectively addressing the problem of local occlusion, different associative cues are better utilized to enhance the model's learning ability. A multi-cue associative learning method based on graph neural networks is provided to solve the problem of expression recognition in natural scenarios.

The present invention provides a facial expression recognition method and system based on multi-cue associative learning, where a feature-level attention mechanism effectively integrates the knowledge of multi-cue associative learning, making the model more consistent with human associative learning mechanisms, so the complex and varied challenges in natural scenarios are better addressed.

The present invention provides a facial expression recognition method and system based on multi-cue associative learning, where the student model and the teacher model are further optimized by using knowledge distillation. On one hand, knowledge distillation may regard associative learning as a regularization peak of a conventional convolutional neural network, so the computational resources required by the model during the testing phase are reduced. On the other hand, the collaborative training of the teacher model and the student model can further optimize the backbone network of the model, so the performance of the teacher model is further improved.

A person having ordinary skill in the art should be able to easily understand that the above description is only preferred embodiments of the present invention and is not intended to limit the present invention. Any modifications, equivalent replacements, and modifications made without departing from the spirit and principles of the present invention should fall within the protection scope of the present invention.

What is claimed is:

1. A facial expression recognition method based on multi-cue associative learning, characterized in comprising following steps:
inputting a pre-recognized facial image into a student model and/or a teacher model for facial expression recognition,
wherein a training method of the student model and the teacher model comprises following steps:
D1: cropping a global facial sample image to obtain an upper half facial sample image and a lower half facial sample image in a horizontal direction;
D2: extracting cue features from the global facial sample image, the upper half facial sample image, and the lower half facial sample image;
D3: calculating an association relationship among the cue features corresponding to the upper half facial sample image, the lower half facial sample image, and the global facial sample image, and acquiring corresponding adjacency matrices;
D4: with the cue features and the adjacency matrices as input, outputting associated semantics by using three graph convolutional networks and fusing the associated semantics by using a feature-level attention mechanism, so as to acquire the teacher model; and
D5: inputting the fused associated semantics in the teacher model into a classification layer, supervising training of the teacher model by using a cross-entropy loss, and supervising training of the student model by using label distillation, Kullback-Leibler (KL) divergence, and a cross-entropy loss together, wherein the student model is constructed by a fully-connected layer input after the cue features pass through a bottleneck layer.

2. The facial expression recognition method according to claim 1, wherein the teacher model is constructed in one of two approaches:
wherein one approach is:
outputting global associated semantics by treating the cue features of the global facial sample image as a first input for the three graph convolutional networks, and treating the adjacency matrices corresponding to the global facial sample image, the upper half facial sample image, and the lower half facial sample image as a second input for a first, second, and third graph convolutional networks respectively; and fusing the global associated semantics by using the feature-level attention mechanism, so as to acquire the teacher model;
another approach is:
outputting the global associated semantics, upper half facial sample associated semantics, and lower half facial sample associated semantics respectively by treating the cue features corresponding to the global facial sample image, the upper half facial sample image, and the lower half facial sample image as the first input for the first, second, and third graph convolutional networks respectively, and treating the adjacency matrices corresponding to the global facial sample image, the upper half facial sample image, and the lower half facial sample image as a second input for the first, second, and third graph convolutional networks respectively; and fusing the global associated semantics, the upper half facial sample associated semantics, and the lower half facial sample associated semantics by using the feature-level attention mechanism, so as to acquire the teacher model.

3. The facial expression recognition method according to claim 1, wherein extracting the cue features comprises: performing feature extraction by using a local binary pattern (LBP) operator; or directly extracting deep features by using a public and trained face model; or fine-tuning a pre-trained face model by using labeled samples to acquire a deep model and then extracting deep embedding features by using the deep model.

4. The facial expression recognition method according to claim 2, wherein a cross-entropy loss function of the teacher model is:
$${ℒ}_{cls}^{t} = - {\sum }_{i = 1}^{n} {y}_{i} log {\hat{y}}_{i}^{t} ,$$
wherein ŷᵢ^{t} represents a sample label distribution predicted by the fully-connected layer of the fused associated semantics F(x) in the teacher model, and yᵢ represents a true distribution of the sample.

5. The facial expression recognition method according to claim 4, wherein a total loss function of the student model comprises a distillation loss function and a cross-entropy loss function of the student model, specifically is:
$${ℒ}_{s} = {ℒ}_{cls}^{s} + {ℒ}_{KL} , \\ {ℒ}_{cls}^{s} = - {\sum }_{i = 1}^{n} {y}_{i} log {\hat{y}}_{i}^{s} , and \\ {ℒ}_{KL} = - {\sum }_{i = 1}^{n} f ( {\hat{y}}_{i}^{s} / T ) log \frac{f ( {\hat{y}}_{i}^{t} / T )}{f ( {\hat{y}}_{i}^{s} / T )} ,$$
wherein [symbol] _{cls}^{s} represents the cross-entropy loss of the student model, ŷᵢ^{s} represents a probability distribution predicted by the student model, [symbol] _{KL} is a distillation loss, f(.) represents a softmax activation function, T represents a distillation temperature, and ŷᵢ^{t} represents a sample label distribution predicted by the fully-connected layer of the fused associated semantics F(xᵢ) in the teacher model.

6. A facial expression recognition system based on multi-cue associative learning, characterized in comprising:
a student model expression recognition module, configured to input a pre-recognized facial image into a storage module of a student model to perform facial expression recognition;
a teacher model expression recognition module, configured to input the pre-recognized facial image into a storage module of a teacher model to perform facial expression recognition;
a global facial sample image preprocessing module, configured to crop a collected global facial sample image to obtain an upper half facial sample image and a lower half facial sample image in a horizontal direction;
a feature extraction module, configured to extract cue features from the global facial sample image, the upper half facial sample image, and the lower half facial sample image;
an adjacency matrix acquisition module, configured to calculate an association relationship among the cue features corresponding to the upper half facial sample image, the lower half facial sample image, and the global facial sample image, and acquire adjacency matrices corresponding to the upper half facial sample image, the lower half facial sample image, and the global facial sample image;
a teacher model construction module, configured to, with the cue features and the adjacency matrices as input, output associated semantics by using three graph convolutional networks and fuse the associated semantics by using a feature-level attention mechanism, so as to acquire the teacher model; and
a model training module, configured to input the fused semantics association in the teacher model into a classification layer, supervise training of the teacher model by using a cross-entropy loss function of the teacher model, and supervise training of the student model by using label distillation, Kullback-Leibler (KL) divergence, and a cross-entropy loss of the student model together,
wherein the student model is constructed by a fully-connected layer input after the cue features pass through a bottleneck layer.

7. The facial expression recognition system according to claim 6, wherein the teacher model is constructed in one of two approaches:
wherein one approach is:
outputting global associated semantics by treating the cue features of the global facial sample image as a first input for the three graph convolutional networks, and treating the adjacency matrices corresponding to the global facial sample image, the upper half facial sample image, and the lower half facial sample image as a second input for a first, second, and third graph convolutional networks respectively; and fusing the global associated semantics by using the feature-level attention mechanism, so as to acquire the teacher model;
another approach is:
outputting the global associated semantics, upper half facial sample associated semantics, and lower half facial sample associated semantics respectively by treating the cue features corresponding to the global facial sample image, the upper half facial sample image, and the lower half facial sample image as the first input for the first, second, and third graph convolutional networks respectively, and treating the adjacency matrices corresponding to the global facial sample image, the upper half facial sample image, and the lower half facial sample image as a second input for the first, second, and third graph convolutional networks respectively; and fusing the global associated semantics, the upper half facial sample associated semantics, and the lower half facial sample associated semantics by using the feature-level attention mechanism, so as to acquire the teacher model.

8. The facial expression recognition system according to claim 6, wherein extracting the cue features comprises: performing feature extraction by using a local binary pattern (LBP) operator; or directly extracting deep features by using a public and trained face model; or fine-tuning a pre-trained face model by using labeled samples to acquire a deep model and then extracting deep embedding features by using the deep model.

9. The facial expression recognition system according to claim 6, wherein the cross-entropy loss function of the teacher model is:
$${ℒ}_{cls}^{t} = - {\sum }_{i = 1}^{n} {y}_{i} log {\hat{y}}_{i}^{t} ,$$
wherein ŷᵢ^{t} represents a sample label distribution predicted by the fully-connected layer of the fused associated semantics F(xᵢ) in the teacher model, and yᵢ represents a true distribution of the sample.

10. The facial expression recognition system according to claim 9, wherein a total loss function of the student model comprises a distillation loss function and a cross-entropy loss function of the student model, specifically is:
$${ℒ}_{s} = {ℒ}_{cls}^{s} + {ℒ}_{KL} , \\ {ℒ}_{cls}^{s} = - {\sum }_{i = 1}^{n} {y}_{i} log {\hat{y}}_{i}^{s} , and \\ {ℒ}_{KL} = - {\sum }_{i = 1}^{n} f ( {\hat{y}}_{i}^{s} / T ) log \frac{f ( {\hat{y}}_{i}^{t} / T )}{f ( {\hat{y}}_{i}^{s} / T )} ,$$
wherein [symbol] _{cls}^{s} represents the cross-entropy loss of the student model, ŷᵢ^{s} represents a probability distribution predicted by the student model, [symbol] _{KL} is a distillation loss, f(.) represents a softmax activation function, T represents a distillation temperature, and ŷᵢ^{t} represents a sample label distribution predicted by the fully-connected layer of the fused associated semantics F(xᵢ) in the teacher model.
